(19) United States
(12) Patent Application Publication
(10) Pub. No.: US 2012/0006081 A1
(43) Pub. Date: Jan. 12, 2012

(54) LOCK AND DOOR UTILIZING THE SAME

(75) Inventor: KONGHUA TAN, GUANGDONG (CN)

(73) Assignee: GULI SECURITY PRODUCTS LIMITED, GUANGDONG (CN)

(21) Appl. No.: 12/944,076

(22) Filed: Nov. 11, 2010

(30) Foreign Application Priority Data
Jul. 12, 2010 (CN) 201010225435.8

(51) Int. Cl. E05B 65/08; E05C 5/02

(52) U.S. Cl. 70/95; 292/110

(57) ABSTRACT

The present disclosure relates to a lock for a sliding door. The lock includes a locking assembly, a controlling plate, and a locking dish. The locking assembly includes a locking module, a reverting module, and a housing with a panel. The driving module drives the locking module to extend out of the panel. In the embodiments, the locking assembly can be driven to extend out of the panel to be used as a handle, thus, a door utilizing the lock can be drawn or pulled the locking module.

### FIELD OF THE INVENTION

The present disclosure relates to locks, especially o a lock without handle and a door utilizing the lock.

### DESCRIPTION OF THE RELATED ART

A large variety of locks are used with sliding door or window frames, aiming at locking the sliding door/window panel into a facing part located within the frame.

A most common type of frame amongst aluminum frames is that which in the region wherein the sliding door/window panel locks is provided with a protruding and vertically extending part of the frame profile which penetrates into a front opening of the vertically extending part of the profile of the sliding door/window panel, which consists of parallel walls and ends to a rear opening wherein a glass or shutter panel is fitted. An internal or external lock can be alternatively used with this type of frame/sliding panel profiles. A handle is usually needed to draw the door/window to lock or push the door/window to open. However, due to rigidity limited, the thickness of the door/window should not be made too thin.

Therefore, there is room for improvement within the art.

### SUMMARY OF THE INVENTION

One embodiment of the present disclosure relates to a lock for a sliding door/window. The lock includes a locking assembly, a controlling plate, and a locking dish. The locking assembly includes a locking module, a reverting module, and a housing with a panel. The driving module drives the locking module to extend out of the panel. In this embodiment, the locking assembly can be driven to extend out of the panel to be used as a handle, thus, a door utilizing the lock can be drawn or pulled the locking module.

These and other features of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Many aspects of lock and door utilizing the door can be better understood with reference to the following drawings. The components in the drawings are not necessarily drawn to scale, the emphasis instead being placed upon clearly illustrating the principles of the lock and the door using the lock. Moreover, in the drawings, like reference numerals designate corresponding parts throughout the views.

FIG. 1 is an assembled, isometric view of an embodiment of a lock.

FIG. 2 is an exploded, isometric view of the lock shown in FIG. 1.

FIG. 3 is a cross sectional view of the lock of FIG. 1, but showing a panel secured to a lock assembly.

FIG. 4 is a cross sectional view of the lock, showing the lock in an open state.

FIG. 5 is a top view of an indexing shell.

FIG. 6 is a cross sectional view of the indexing shell of FIG. 5.

FIG. 7 is similar to FIG. 6, but viewed from another aspect.

FIG. 8 is an isometric view of a first housing of the lock of FIG. 1.

FIG. 9 is an assembled view of the lock, in a locked state.

FIG. 10 is similar to FIG. 9, but showing the lock in unlocked state.

FIG. 11 is similar to FIG. 10, showing a button used as a handle.

FIG. 12 is similar to FIG. 11, but showing the button further pushed.

FIG. 13 is an isometric view, showing the lock in a locked state.

FIG. 14 is a cross sectional view of the lock shown in FIG. 10.

FIG. 15 is an isometric view of a door utilizing the lock.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

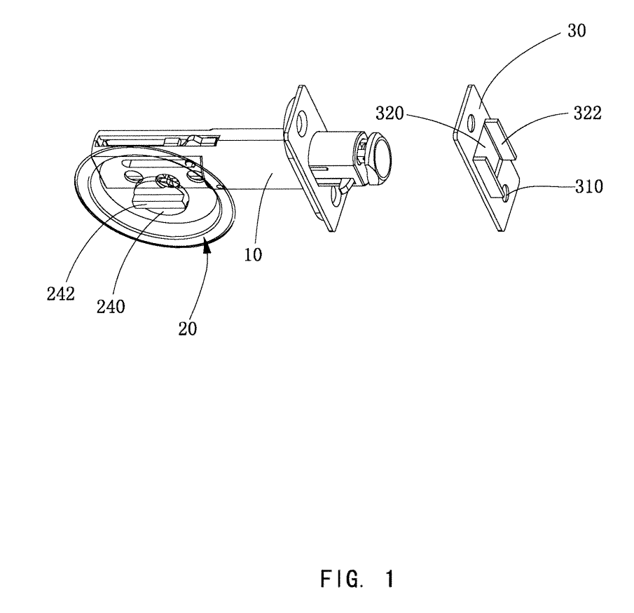

FIG. 1 is an assembled, isometric view of an embodiment of a lock. The lock includes a locking assembly 10, a controlling plate 20, and a locking dish 30. The controlling plate 20 and the locking dish 30 are respectively secured to the locking assembly 10, and the locking plate 20 is for controlling the locking assembly 10 locked/unlocked and the locking dish 30 hooks the locking assembly 10.

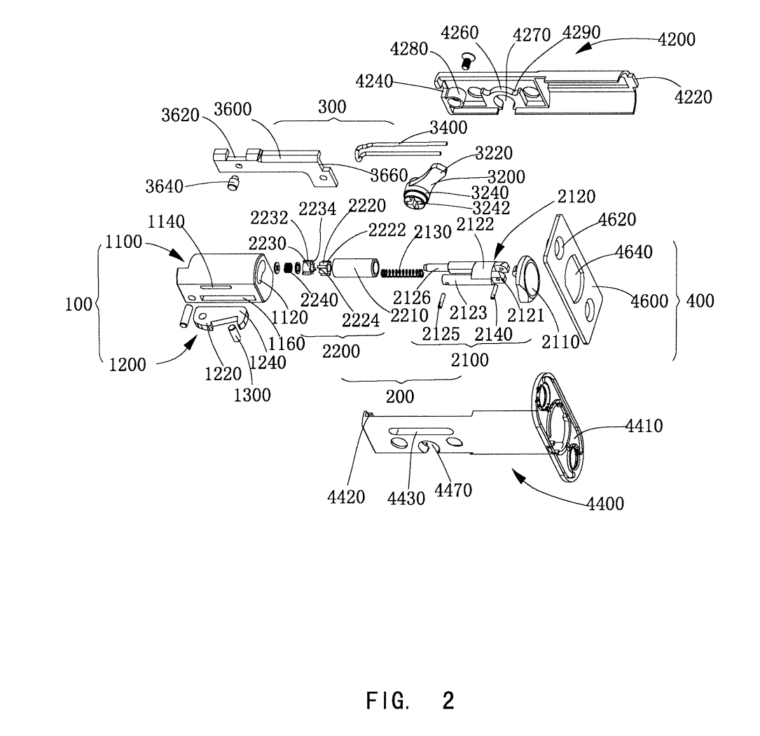

Referring to FIG. 2, the locking assembly 10 includes a locking module 100, a reverting module 200, a driving module 300, and a housing 400. The housing 400 encloses the locking module 100, the reverting module 200, and the driving module 300. The reverting module 200 is for reverting the locking module 100, and the driving module 300 drives the locking module 100.

The locking module 100 includes a receiving sleeve 1100, a locking hook 1200, and a rotating shaft 1300. The receiving sleeve 1100 defines a receiving cavity 1120 on a side surface thereof. The receiving sleeve 1100 including two planes on opposite sides. Along the axial direction of the receiving sleeve 1100, one of the planes defines a first slot 1140 and a second slot 1160, and the second slot 1160 is substantially parallel to and is longer the than the first slot 1140.

Referring to FIG. 3, the locking hook 1200 is rotatably received in the second slot 1160. The locking hook 1200 includes a head portion 1220 and a locking portion 1240. The head portion 1220 is rotatably secured to the receiving sleeve 1200 by the rotating shaft 1300. The locking portion 1240 can be rotated out of the receiving sleeve 1200 to hook the housing 400.

Referring FIG. 2, the reverting module 200 includes an operating mechanism 2100 and an indexing mechanism 2200. In the illustrated embodiment, the operating mechanism 2100 includes a button 2110, a connecting element 2120, a first spring 2130, a first pin 2140 and a second pin 2125. The button 2110 is rotatably connected to the connecting element 2120. The connecting element 2120 is slidably received in the receiving cavity 1120. The connecting element 2120 includes a base portion 2122, a seat portion 2121, a first leg portion 2123, and second leg portion 2126. The seat portion 2121 is oriented at one end of the base portion 2122, and the first and second leg portions 2123 and 2126 are oriented in opposite end of the base portion 2122. The first leg portion 2123 is substantially parallel to and shorter than the second led portion 2126. The first spring 2130 is placed around the second leg portion 2126. When the button 2110 is hinged to the seat portion 2121 by the first pin 2140, the button 2110 can rotate relative to the seat portion 2120 at angle of 120 degrees.

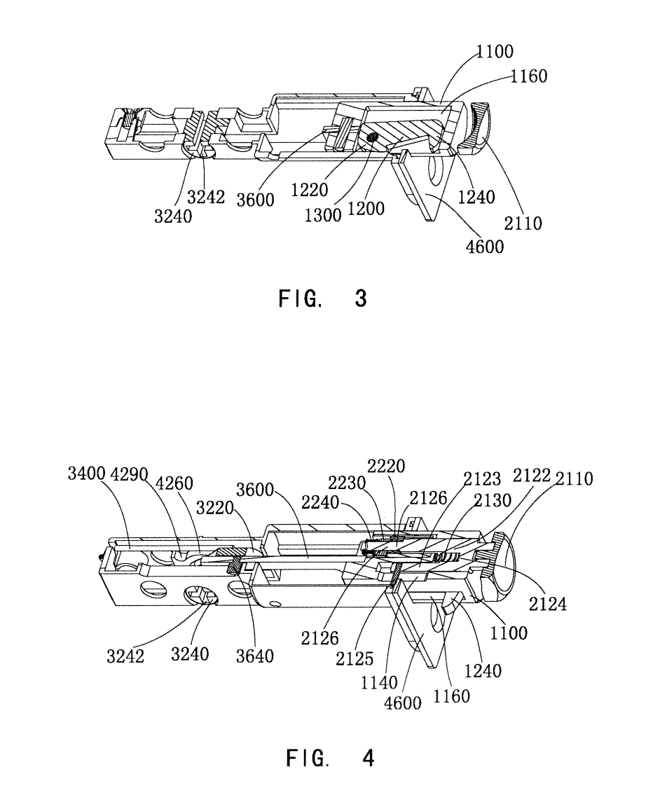

Referring to FIG. 4, the base portion 2122 defines a receiving groove 2124 therein. The first spring 2130 is received in the receiving groove 2124. A pin hole in defined in the first leg portion 2123, in which one end of the second pin 2125 is received. The other end of the second pin 2125 is received in the first slot 1140 of the receiving sleeve 1100. When the second pin 2125 slides along the first slot 1140, the connecting element 2120 move to and fro in the receiving cavity of the receiving sleeve 1100 with the same distance.

Referring to FIG. 2, the indexing module 2200 includes an indexing sleeve 2210, a first dividing wheel 2220, a second dividing wheel 2230, and a second spring 2240. The first dividing wheel 2120 and the second dividing wheel 2230 are placed around the second leg 2126 of the connecting element 2126 in sequence. The connecting element 2120 moves to and fro by the engagement of the first and second diving wheels 2120 and 2130. The second spring 2240 is secured to the second leg portion 2126 by a washer not labeled) and is retained on the second leg portion 2126 by riveting. The first and second dividing wheels 2221 and 2230 are received in the indexing sleeve 2210.

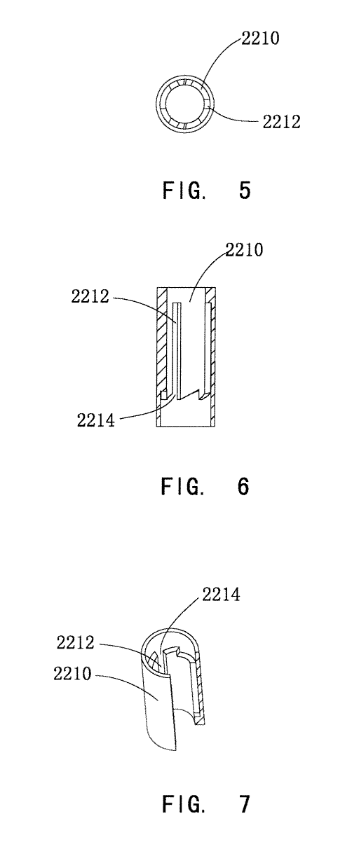

Referring to FIGS. 5 through 7, three guiding slots 2212 are defined in the inner wall of the indexing sleeve 2210 in trisection. Six notches 2214 are defined in one end of the indexing sleeve 2210, the distance between adjacent notches are equal to each other. Every other notch 2214 communicates with the corresponding guiding slot 2212. Three first guiding ribs 2222 project from the outer surface of the first dividing wheel 2220. Six first indentations 2224 are defined in one end of the first diving wheel 2220, each first indentation 2224 includes an angled surface. The climax of the each first indentation 2224 aligns with the corresponding first guiding ribs 2222. The features of the second dividing wheel 2230 are substantially the same as the first dividing wheel 2220. Three second guiding ribs 2232 project from the outer surface of the second dividing wheel 2230, and six second indentation 2234 are defined in the inner surface of the second dividing wheel 2230, but the climax of each second indentation 2234 aligns with the edge of the corresponding second guiding rib 2232. When the first dividing wheel 2220 engages the second dividing wheel 2230, the first dividing wheel 2220 moves in the indexing sleeve 2210 up and down.

When the second guiding ribs 2232 are received in the corresponding notches 2214 not communicating with the corresponding guiding slots 2212, the second dividing wheel 2230 gets stuck, which makes the connecting get stuck. When the connecting element 2210 axially moves to and fro, the connecting element 2210 drives the second dividing wheel 2230 to moves in axial direction and to separate from the guiding slots 2212 by the first dividing wheel 2220. When the second dividing wheel 2230 is driven by axial force, the second dividing wheel 2230 rotates about the second leg portion 2126 at 60 degrees each time.

Referring to FIG. 2, the driving module 300 includes a driving element 3200, an elastic element 3400, and a driving plate 3600. Both the driving plate 3600 and the elastic element 3400 are secured to the driving element 3200. In the illustrated embodiment, the driving element 3200 includes a driving portion 3220 and a connecting portion 3240. A receiving slot 3620 in defined in one end of the driving plate 3600. The driving portion 3220 passes through the receiving slot 3620, the driving plate 3600 can move to and fro in the housing 400. One end of the driving plate 3600 resists against the second dividing wheel 2200 and is driven by the second dividing wheel 2200. The other end of the driving plate 3600 is riveted to the receiving sleeve 1100. A cross-notch 3242 is longitudinally defined in the connecting portion 3240. The cross-notch 3242 is substantially parallel to the driving portion 3220.

The elastic element 3400 includes a first arm and a second arm, the first arm and second arm are connected by a substantially U-shaped portion, the U-shaped portion is substantially perpendicular to the first and second arms, as shown in FIG. 2. One arm resists the inner wall of the housing 400, and the other arm resists and to place the driving element 3200.

Referring also to FIG. 2, the housing 400 includes a first cover 4200, a second cover 4400, and a panel 4600. The first cover 4200 and the second cover 4400 are oriented opposite to each other and are fixed together by the panel 4600. In the illustrated embodiment, one end of the first cover 4200 latches with the second cover 4400, and the other end of the first cover 4200 resists and is fixed to the second cover 4600 by bolt (not shown). The panel 4600 is fixed to the second cover 4400 by riveters (not shown). Two receiving holes 4620 and a through hole 4640 are defined in the panel 4600, the two receiving holes 4620 are oriented at opposite sides of the through hole 4640. A receiving space is cooperatively defined by the first cover 4200, the second cover 4400, and the panel 4600. The locking module 100 and the driving module 300 are received in the receiving space.

In the illustrated embodiment, the receiving sleeve 1100 is received in the upper receiving space and can extend out of the panel 4600. A projection 4220 extends from one end of the first cover 4200. An opening 4240 is defined in the other end of the first cover 4200, through which the elastic element 3400 passes. A hollow 4260, a vent 4270, and a fixing hole 4280 are defined in the inner surface of the first cover 4200. The vent 4270 accommodates the driving element 3200. The sidewall of the hollow 4260 forms an arcuate rail, with opposite ends lower and forming a recess 4290 at each end. Each recess 4290 is for accommodating the fixing portion (not shown) of the driving portion 3220. When the fixing portion slides along the hollow 4260, the recesses 4290 are substantially perpendicular to the fixing portion of the driving element 3200. The first cover 4200 is fixed to the second cover 4400 by bolts received in the fixing hole 4280.

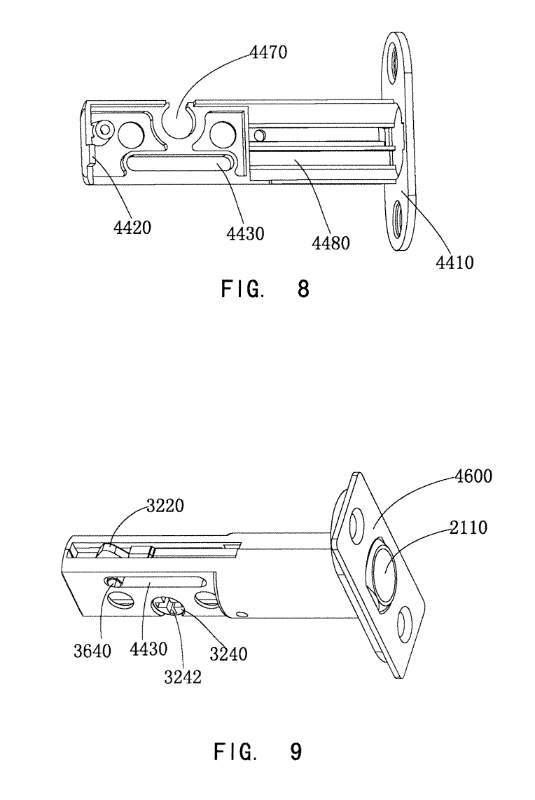

Referring to FIG. 8, a side plate 4410 projects from one end of the second cover 4400 to accommodate the panel 4600. A block projects 4420 from the other end of second cover 4400. A side slot 4430 and a mounting hole 4470 are defined in the inner surface of the second cover 4400. The block 4420 is received in opening 4240. The side slot 4430 is to slidably receive 3640. A rail 4480 is formed on the inner surface of the second cover 4400. The rail 4480 is used to assist to rotate the locking portion 1240 when the locking portion 1240 resists the panel. The shape of the housing 400 can be oblate or cylindrical at the end adjacent the side plate 4410.

Referring to FIGS. 1 and 2 again, the controlling plate 20 is received in the cross-notch 3242. When the controlling plate 20 rotates about the cross-notch 3242, the controlling plate 20 drives the driving element 3200. The controlling pate 20 includes a disk 220 and a knob 240. In the illustrated embodiment, the knob 240 is formed on the disk 220 and acts as a handle 242 to rotate the driving element 3200. A plugging portion (not shown) projects from the disk 220 and can be inserted into the cross-notch 3242 to rotate the driving element 3200. In the illustrated embodiment, the plugging portion is a block accommodating the cross-notch 3242.

The locking element 30 is for being hooked by the locking module 10. A locking hole 320 and two fixing holes 310 are defined in the locking element 30, the fixing holes 310 are oriented at opposite sides of the locking hole 320. The locking element 30 is secured to a door (as described late, in FIG. 15) by fasteners passing through the fixing holes 310. The locking hole 320 corresponds to the locking assembly 10. Two beam portions 322 project from the locking element 30. The two beam portions 322 are oriented at opposite edges of the locking hole 320. A receiving cavity is defined by the beam portions 322. The locking module 10 can extend out of the housing 400 and pass the locking hole 320 and received in the receiving cavity. The beam portions 322 hook with the locking hook 1200 to lock the door (as shown in FIG. 8).

Referring to FIG. 9, in the illustrated embodiment, the receiving sleeve 1100 is received in the housing 400. When the button 2110 is pressed, the button 2110 pushes the connecting element 2120. The connecting element 2120 drives the second dividing wheel 2230 to slide along the guiding slot 2212 by the first dividing wheel 2220. The movement of the first diving wheel 2220 is restricted and is retained in the guiding slot 2212, thus, the second diving wheel 2230 is forced to move along the guiding slot 2212 before entering into the notches 2214. When the second dividing wheel 2230 enters the notches 2214 and separates from the indexing sleeve 2210, the rotation moment disappears, and the second dividing wheel 2230 rotates in a given direction, such as in the clockwise direction, at 60 degrees. The second dividing wheel 2230 further rotates 60 degrees in the same direction by the elastic force of the second spring 2240 and enters into the indexing sleeve 2110 again. The second guiding ribs 2232 enter the corresponding guiding slots 2212 and slides along the guiding slots 2212 until the first guiding ribs 2222 resists the corresponding end wall of the guiding slots 2212. The connecting element 2120 is pushed under the elastic force of the first spring 2130. The second pin 2125 is received in first slot 1140, so that a length of the connecting element 2120 is controlled.

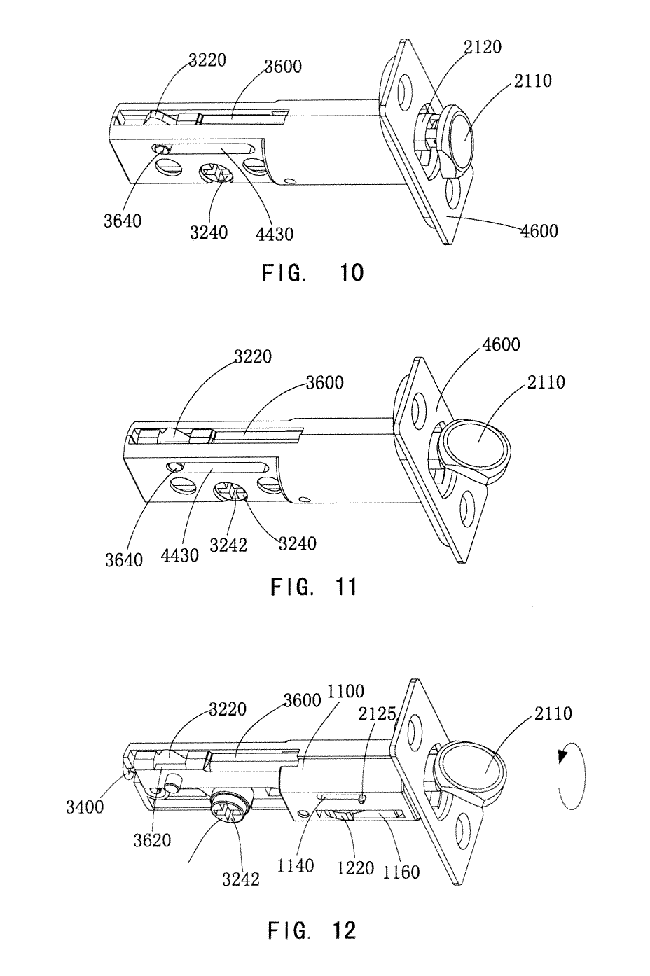

Referring to FIG. 10, when the button 2110 is pressed again, as described above, the second dividing wheel 2230 separates from the guiding slots 2212 again, and the second dividing wheel 2230 rotates another 60 degrees in the same direction. Then the second dividing wheel 2230 enters into the guiding slot 2212 and returns to its original position. Therefore, by pressing the button 2110, the connecting element 2120 can be completed received in the housing 400 or can extend out of the panel 4600.

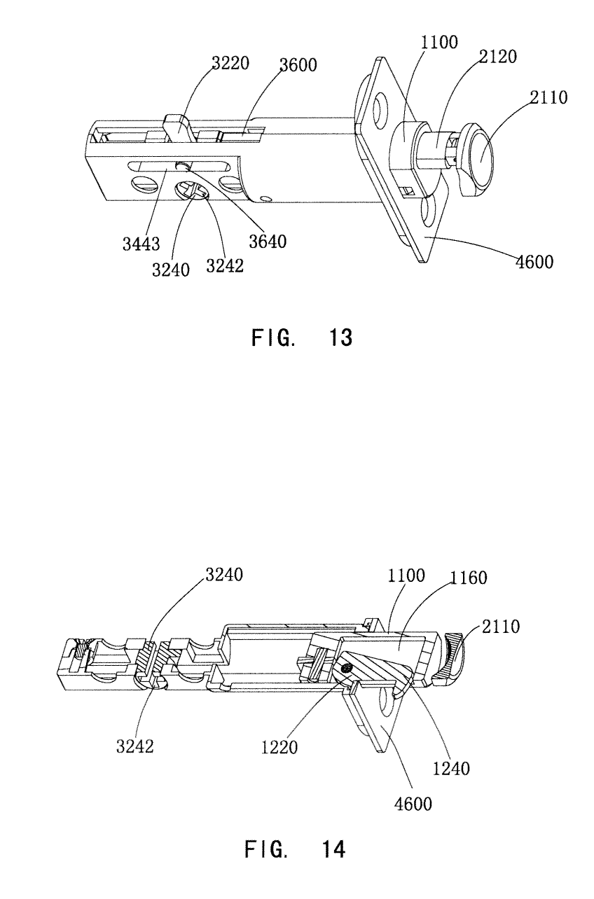

Referring to FIG. 11, the button 2110 and part of the connecting element 2120 extend out of the panel 4600, and the button 2110 can be rotate about the first pin 2140 at an angle of 120 degrees, so that the button 2110 can act as a handle. At the same time, the second pin 2125 resists the receiving sleeve 1100. Referring to FIG. 12, the moment of M passes to the receiving sleeve 110 by the first pin 2125 and the indexing module 2200 won't be pressed.

To make the receiving sleeve 1100 self-locking after the sleeve 1100 is pushed to extend out of the panel 4600, the driving portion 3220 of the driving element 3200 is received and rotates in the hollow of the housing 400. Referring to FIGS. 4, 11 and 13, the driving element 3200 pushes the locking assembly 100 to extend out of the panel 4600. When the driving portion 3220 slides along the hollow 4260 from one recess 4290 to the other recess 4290, the elastic element 3400 resists the driving element 3200. At the same time, the driving portion 3220 is received in the receiving slot 3620 to lock the receiving sleeve 1100 in the axial direction. When the driving element 3200 is rotated in opposite direction, the locking assembly 100 is completely received in the receiving sleeve 1100 and is locked.

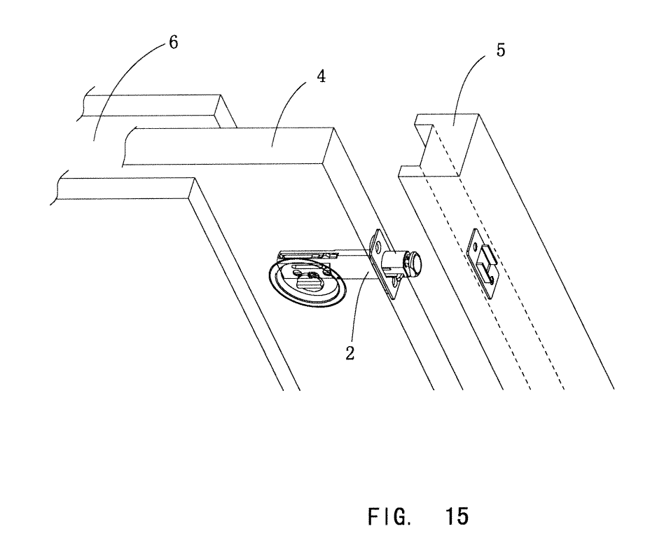

Referring to FIG. 4, when the locking assembly 100 is pushed, the first pin 2125 resists the panel 4600. When the connecting element 2120 is pressed, as the button 2100 is pressed that is described above, the button 2110 is drawn back to its original position. Referring to FIGS. 3, 8, and 14, when the locking assembly 100 is pushed out of the housing 400, both ends of the locking hook 1200 are parallel to the receiving sleeve 1100. When the locking portion 1240 resists the panel 4600, a differential between the panel 4600 and the rail 4480 of the second cover rotates the locking hook 1200. The hook portion is rotated to lock the door. When the locking assembly 100 returns to the housing 400, the locking portion 1240 of the locking hook 1200 rotates in opposite direction, the head portion 1220 and locking portion 1240 align again with the receiving sleeve 1100, the locking portion 1240 separates from the door, so that the door is unlocked and can be opened.

Referring to FIG. 15, a sliding door includes a door panel 4, a frame 4 accommodating to the door panel 4, and a lock 2.

In an unlocked state, the door panel 4 is received in a receiving chamber 6. And in a locked state, the door panel 4 resists the frame 5, the lock 2 is oriented at the door panel 4 and the frame 5 to fixed the door panel 4 to the frame 5.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

What is claimed is:

1. A lock comprising:
locking assembly comprising:
a locking module;
a reverting module elastically resisting the locking module;
a housing comprising a panel; and
a driving module driving the locking module to extend out of the panel;
a controlling plate, the controlling plate controlling the rotation of the locking assembly; and
a locking dish hooking with the locking module.

2. The lock of claim 1, wherein the locking module comprises a receiving sleeve, a locking hook, and a rotating shaft, the locking hook is rotatably secured to the receiving sleeve by the rotating shaft.

3. The lock of claim 2, wherein the receiving sleeve defines a first slot and a second slot along axial direction, a length of the first slot is shorter than the second slot, the locking hook is rotatably received in the second slot.

4. The lock of claim 1, wherein the reverting module comprises an operating mechanism and an indexing mechanism, when the operating mechanism is pressed, the indexing mechanism moves to select the lock in locked or unlocked state.

5. The lock of claim 4, wherein the operating mechanism comprises a button, a connecting element, and a first spring, the button is rotatably connected to the connecting element, the connecting element is slidably received in the locking assembly, the first spring elastically resists the connecting element.

6. The lock of claim 5, wherein the connecting element comprises a base portion, a seat portion, a first leg portion, and a second leg portion, the seat portion is oriented at one end of the base portion, the button is hinged to the seat portion, the first and second leg portions are oriented at the other end of the base portion, the first leg portion is parallel to the second leg portion.

7. The lock of claim 6, wherein the indexing mechanism comprises an indexing sleeve, a first dividing wheel, a second dividing wheel, and a second spring, the indexing sleeve, the first dividing wheel, the second dividing wheel, and the second spring are placed around and are retained at the second leg portion of the connecting element.

8. The lock of claim 7, wherein the indexing sleeve defines three guiding slots in an inner wall thereof in trisection, six notches are defined in one end of the indexing sleeve, every other notch communicate with the corresponding guiding slot.

9. The lock of claim 8, wherein a plurality of first guiding ribs project from the outer surface of the first dividing wheel, a plurality of first indentations are defined in one end of the first diving wheel, each first indentation comprises an angled surface, the climax of the each first indentation aligns with the corresponding first guiding ribs.

10. The lock of claim 7, wherein a plurality of second guiding ribs project from the outer surface of the second dividing wheel, and a plurality of second indentation are defined in the inner surface of the second dividing wheel, the climax of each second indentation aligns with the edge of the corresponding second guiding rib.

11. A door comprising:
a sliding door, a frame, and a lock, the sliding door locked to the frame by the lock, and the clock comprising:
locking assembly comprising:
a locking module;
a reverting module elastically resisting the locking module;
a housing comprising a panel; and
a driving module driving the locking module to extend out of the panel;
a controlling plate, the controlling plate controlling the rotation of the locking assembly; and
a locking dish hooking with the locking module.

12. The lock of claim 11, wherein the locking module comprises a receiving sleeve, a locking hook, and a rotating shaft, the locking hook is rotatably secured to the receiving sleeve by the rotating shaft.

13. The door of claim 12, wherein the receiving sleeve defines a first slot and a second slot along axial direction, a length of the first slot is shorter than the second slot, the locking hook is rotatably received in the second slot.

14. The door of claim 11, wherein the reverting module comprises an operating mechanism and an indexing mechanism, when the operating mechanism is pressed, the indexing mechanism moves to select the lock in locked or unlocked state.

15. The door of claim 14, wherein the operating mechanism comprises a button, a connecting element, and a first spring, the button is rotatably connected to the connecting element, the connecting element is slidably received in the locking assembly, the first spring elastically resists the connecting element.

16. The door of claim 15, wherein the connecting element comprises a base portion, a seat portion, a first leg portion, and a second leg portion, the seat portion is oriented at one end of the base portion, the button is hinged to the seat portion, the first and second leg portions are oriented at the other end of the base portion, the first leg portion is parallel to the second leg portion.

17. The door of claim 16, wherein the indexing mechanism comprises an indexing sleeve, a first dividing wheel, a second dividing wheel, and a second spring, the indexing sleeve, the first dividing wheel, the second dividing wheel, and the second spring are placed around and are retained at the second leg portion of the connecting element.

18. The door of claim 17, wherein the indexing sleeve defines three guiding slots in an inner wall thereof in trisection, six notches are defined in one end of the indexing sleeve, every other notch communicate with the corresponding guiding slot.

19. The door of claim 18, wherein a plurality of first guiding ribs project from the outer surface of the first dividing wheel, a plurality of first indentations are defined in one end of the first diving wheel, each first indentation comprises an angled surface, the climax of the each first indentation aligns with the corresponding first guiding ribs.

20. The door of claim 17, wherein a plurality of second guiding ribs project from the outer surface of the second dividing wheel, and a plurality of second indentation are defined in the inner surface of the second dividing wheel, the climax of each second indentation aligns with the edge of the corresponding second guiding rib.
